(19) United States
(12) Patent Application Publication
(10) Pub. No.: US 2024/0290160 A1
(43) Pub. Date: Aug. 29, 2024

(54) BILL PROCESSOR

(71) Applicant: Asahi Seiko Co., Ltd, Tokyo (JP)

(72) Inventors: Hiroshi ABE, Saitama (JP); Motoharu KUROSAWA, Saitama (JP)

(73) Assignee: Asahi Seiko Co., Ltd, Tokyo (JP)

(21) Appl. No.: 18/585,383

(22) Filed: Feb. 23, 2024

(30) Foreign Application Priority Data
Feb. 24, 2023 (JP) 2023-27662

(51) Int. Cl. G07D 11/50; G07D 7/00; G07D 11/16

(52) U.S. Cl. CPC G07D 11/50; G07D 7/00; G07D 11/16

(57) ABSTRACT

A bill processor includes a circulation conveyance path that can convey a bill to enable circulation thereof. In the circulation conveyance path, a first linear conveyance path and a second linear conveyance path are arranged to oppose each other, upper portions thereof are connected by a first curved conveyance path, and lower portions thereof are connected by a second curved conveyance path. By forming the circulation conveyance path in a rounded rectangular shape in a side view, the bill processor can be downsized in a depth direction. Each functional unit connected to the first linear conveyance path or the second linear conveyance path has a constant entry angle, at which the bill enters/exits the circulation conveyance path. In this way, the bill is conveyed stably.

### BACKGROUND OF THE INVENTION

### 1. Field of the Invention

The present invention relates to a bill processor that accepts and dispenses a bill.

### 2. Description of Related Art

A bill processor is an apparatus that accepts and stores bills, counts the number of the bills, and dispenses the bills, for example.

The bill processor includes: a bill acceptance slot that accepts the bill therein; a bill dispensing slot from which the bill is dispensed to the outside; a conveyance path in which the bill is conveyed; an identification section that identifies a currency denomination of the bill; a sorting section that sorts the bill by currency denomination; and a bill storage device that stores the bill by currency denomination or draws out the stored bill. Such a bill processor accepts the bill from the bill acceptance slot, and identifies the currency denomination of the bill by the identification section that is arranged in the middle of the conveyance path. The bill, the currency denomination of which has been identified, is sorted by currency denomination by the sorting section that is arranged along the conveyance path, and is then stored by currency denomination in the bill storage device. When the bill is dispensed, the bill processor draws out the specified number of the bills of the specified currency denomination from the bill storage device, conveys the bills to the bill dispensing slot, and dispenses the bills. The bill processor is used for a bill exchanger and a change dispenser.

For example, the following bill processor is disclosed in JP6357382B. The bill processor includes a conveyance path that conveys and circulates the bill. A bill accepting slot, a bill ejection slot, and a bill storage are connected to the conveyance path. This bill processor is covered with a case, and includes a mechanism that can pull out an internal device from the case. In this way, a worker can access the inside of the bill processor to perform work such as maintenance work.

In the conventional bill processor, a unit for the bill accepting slot and a unit for the bill ejection slot are arranged on a front side. A unit for the bill storage is arranged on a back side of the bill processor. A conveyance section that includes a cylindrical circulation conveyance section for the bill is arranged in a center of the bill processor. The bill can be circulated in the circulation conveyance section. Each of the units is connected to the bill conveyance section, and the bill enters/exits each of the units from/to the conveyance unit.

Such a bill processor is desired that is small enough to be used in a confined space, such as on a desk, and allows the easy maintenance work.

Since the circulation conveyance section, which is stored in the bill conveyance section, has the cylindrical shape, a size in a depth direction of the bill processor is increased. In addition, since the conveyance section includes a connection conveyance section that connects the circulation conveyance section to each of the functional units such as the bill storage, the size in the depth direction of the bill processor is increased. A connection conveyance path, which is connected to each of the functional units, includes a conveyance path with a tight curve and a conveyance path with a gentle curve. In the conveyance path with the tight curve, a probability of jamming is higher than in the conveyance path with the gentle curve. In addition, since the circulation conveyance section has the cylindrical shape, it is considered that a sufficient space for arranging the connection conveyance path is not obtained, which results in the connection conveyance path with the tight curve. Furthermore, since the circulation conveyance section is stored in the conveyance section, the conveyance path has poor maintainability.

### SUMMARY OF THE INVENTION

The invention provides a bill processor that can be downsized in a depth direction by downsizing a circulation conveyance path for circulating a bill and can convey the bill suitably.

A bill processor according to the invention includes: an accepted bill identification unit having a bill acceptance slot to accept a bill, a separation section to separate a plurality of the accepted bills one by one, and an identification sensor to identify a currency denomination of each of the bills that have been separated one by one; a plurality of storage units, each of which stores the bill; a bill dispensing unit having a bill dispensing slot to dispense the bill to outside; and a circulation conveyance path that conveys the bill to enable circulation thereof. The circulation conveyance path has: a first linear conveyance path; a second linear conveyance path that is arranged to oppose the first conveyance path; a first curved conveyance path that connects one end of the first conveyance path and one end of the second conveyance path and includes a curved section; and a second curved conveyance path that connects another end of the first conveyance path and another end of the second conveyance path and includes a curved section. A conveyance path for the bill in the accepted bill identification unit, a conveyance path for the bill in each of the storage units, and a conveyance path for the bill in the bill dispensing unit are connected to any of the first conveyance path and the second conveyance path, each of which is a linear portion of the circulation conveyance path.

The invention can provide the bill processor in which the circulation conveyance path for circulating the bill can be downsized and which can convey the bill suitably. In addition, with respect to components that constitute the bill conveyance path, the conveyance path with a high degree of freedom in arrangement can be formed, and thus the bill processor can be downsized.

### BRIEF DESCRIPTION OF THE DRAWINGS

FIG. 1 is a view illustrating a configuration of inside of a bill processor;

FIG. 2 is a perspective view of the bill processor;

FIG. 3 is a first view illustrating the configuration of the bill processor;

FIG. 4 is a second view illustrating the configuration of the bill processor;

FIG. 5 is a first view illustrating an overview of functional units of the bill processor; and

FIG. 6 is a second view illustrating the overview of the functional units of the bill processor.

### DESCRIPTION OF EMBODIMENTS

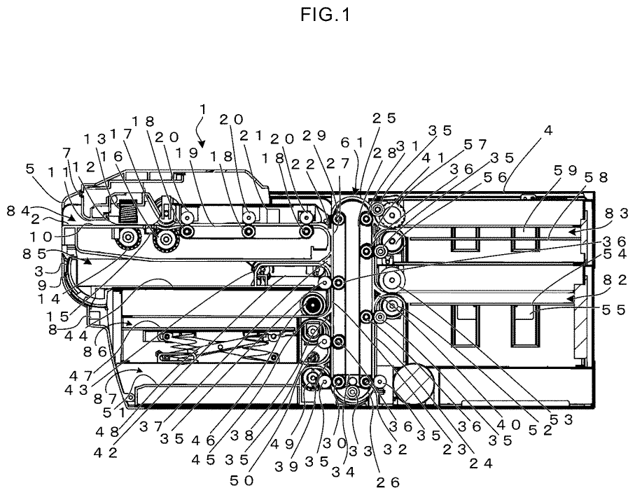

A detailed description will hereinafter be made on an embodiment of the invention with reference to FIGS. 1 to 6. Each drawing provides a view that is schematic to such an extent that the invention can be fully understood. Therefore, the invention is not limited to an illustrated example. In each of the drawings, common components and similar components will be denoted by the same reference sign, and an overlapping description thereon will not be made.

A description will hereinafter be made on a bill processor that processes a bill. Instead of the bill that is used for the bill processor, it is also possible to process sheets of paper similar to the bill. Examples of the sheets of paper are securities, a valuable paper such as a cheque, and a sheet-like paper and a plastic sheet in a predetermined size.

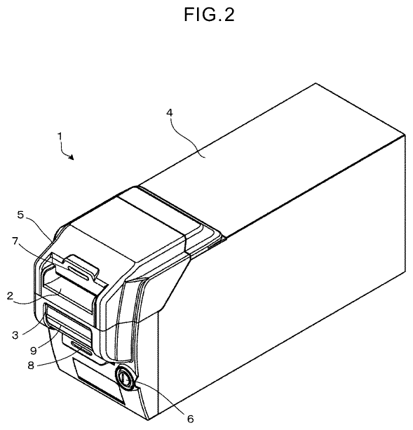

First, a description will be made on external appearance of a bill processor 1 with reference to FIG. 2. FIG. 2 is a perspective view of the bill processor 1. In the bill processor 1, the bill can be inserted from a bill acceptance slot 2 and can be dispensed from a bill dispensing slot 3. A plurality of the stacked bills can be inserted at once into the bill acceptance slot 2 of the bill processor 1. The stacked bills that have been inserted in the bill acceptance slot 2 are separated one by one by a separation section and conveyed to the inside of the bill processor 1. The bill processor 1 is covered with a rear case 4 and a front case 5 to prevent easy access to the inside. Functional units including the front case 5 can be pulled out of the rear case 4. A lock 6 fixes the front case 5 to the rear case 4 and restricts the front case 5 from being pulled out of the rear case 4. The lock 6 restricts the access to the inside of the bill processor 1. The lock 6 is unlocked by a key that corresponds to the lock 6. A first indicator light 7 is turned on when the bill exists in the bill acceptance slot 2, and a second indicator light 8 is turned on when the bill exists in the bill dispensing slot 3. Each of the indicator lights indicates presence or absence of the bill in respective one of the bill acceptance slot 2 and the bill dispensing slot 3.

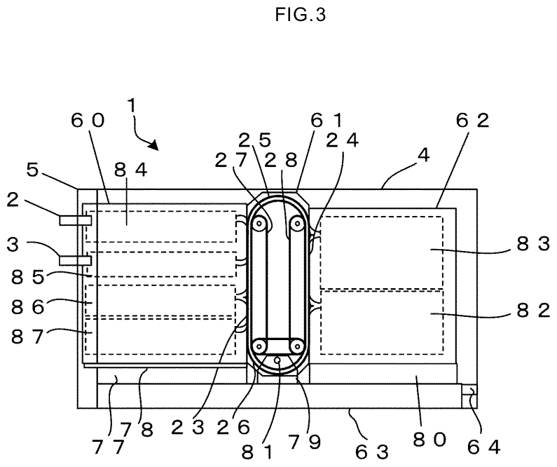

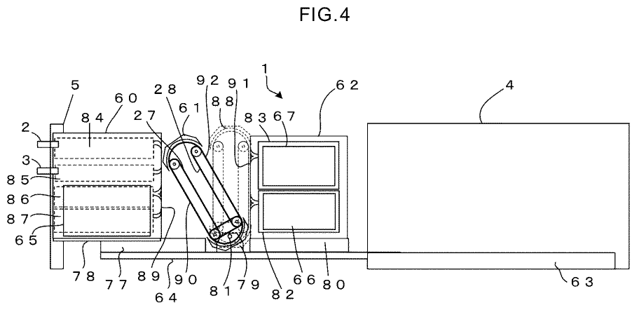

Next, a description will be made on each functional unit stored in the case of the bill processor with reference to FIGS. 3 and 4.

FIG. 3 is a first view illustrating the configuration of the bill processor. FIG. 3 illustrates a state where each of the functional units is stored in the case. FIG. 3 is a side view of the bill processor 1.

In the bill processor 1, the functional units are stored on the inside surrounded by the rear case 4 and the front case 5. Main functional units are: an accepted bill identification unit 84 that accepts the bill and identifies a currency denomination of the bill; a bill dispensing unit 85 that dispenses the bill; a first storage unit 86 that stores and draws out the bill of a first currency denomination; a reject unit 87 that stores the bill to be collected; a circulation conveyance unit 61 that conveys and circulates the bill; a second storage unit 82 that stores and draws out the bill of a second currency denomination; and a third storage unit 83 that stores and draws out the bill of a third currency denomination. For example, the bill of the first currency denomination is a 10,000 Japanese yen bill, the bill of the second currency denomination is a 1,000 Japanese yen bill, the bill of the third currency denomination is a 5,000 Japanese yen bill, and the bill to be collected is a 2,000 Japanese yen bill.

The accepted bill identification unit 84, the bill dispensing unit 85, the first storage unit 86, the reject unit 87, and the front case 5 are fixed to a slide frame 78. The bill acceptance slot 2 and the bill dispensing slot 3 are arranged to the front case 5. The accepted bill identification unit 84 includes the bill acceptance slot 2, and the bill dispensing unit 85 includes the bill dispensing slot 3. The functional units including the accepted bill identification unit 84, the bill dispensing unit 85, the first storage unit 86, and the reject unit 87, which are fixed to the slide frame 78, are collectively referred to as a front unit 60. A second rail 77 is arranged along a depth direction of the bill processor 1. The slide frame 78 slides along the second rail 77 in the depth direction of the bill processor 1, that is, in a right-left direction on the sheet of FIG. 3.

The circulation conveyance unit 61 is rotatably mounted to an intermediate unit support section 79 via a rotational shaft 81. The circulation conveyance unit 61 includes: a first conveyance path 23 that conveys the bill linearly; a second conveyance path 24 that is arranged to oppose the first conveyance path 23 and conveys the bill linearly; and a first curved conveyance path 25 and a second curved conveyance path 26, each of which connects the first conveyance path 23 and the second conveyance path 24. The first conveyance path 23 includes a first belt 27 that is wound around pulleys. The second conveyance path 24 includes a second belt 28 that is wound around pulleys. The first belt 27 and the second belt 28 rotate in an interlocking manner. The bill is conveyed while being held between a pinch roller, which will be described below, and the first belt 27 or between the pinch roller and the second belt 28. When the bill is conveyed and circulated, the bill is sequentially conveyed to the first conveyance path 23, the second curved conveyance path 26, the second conveyance path 24, the first curved conveyance path 25, and the first conveyance path 23.

The second storage unit 82 and the third storage unit 83 are fixed to a rear unit support section 80. The second storage unit 82 and the third storage unit 83, which are fixed to the rear unit support section 80, are collectively referred to as a rear unit 62.

A path for the bill in each of the accepted bill identification unit 84, the bill dispensing unit 85, the first storage unit 86, and the reject unit 87 is connected to the first conveyance path 23. A path for the bill in each of the second storage unit 82 and the third storage unit 83 is connected to the second conveyance path 24.

The rear unit support section 80, the intermediate unit support section 79, and the second rail 77 are fixed to a base frame 64. The base frame 64 includes an engagement section, which is not illustrated and engaged with a first rail 63 in a freely movable manner, and the base frame 64 can be moved along the first rail 63. The first rail 63 is arranged along the depth direction of the bill processor 1, and the first rail 63 and the rear case 4 are fixed to each other. Thus, by moving the base frame 64, each of the functional units fixed to the base frame 64 can be accommodated in the rear case 4 or can be taken out of the rear case 4.

FIG. 4 is a second view illustrating the configuration of the bill processor. FIG. 4 illustrates a state where each of the functional units is placed outside the case. FIG. 4 is a side view of the bill processor 1.

A path for conveying the bill in the first conveyance path 23 is a path that is sandwiched between a first conveyance surface 89 opposing one surface of the bill and a second conveyance surface 90 opposing the other surface of the bill. A path for conveying the bill in the second conveyance path 24 is a path that is sandwiched between a third conveyance surface 91 opposing the one surface of the bill and a fourth conveyance surface 92 opposing the other surface of the bill.

A bill entry/exit slot in each of the functional units of the front unit 60 is arranged to the first conveyance surface 89. The first belt 27 is arranged to the second conveyance surface 90. A bill entry/exit slot in each of the functional units of the rear unit 62 is arranged to the third conveyance surface 91. The second belt 28 is arranged to the fourth conveyance surface 92. A bill conveyance direction of each of the first conveyance path 23 and the second conveyance path 24 crosses a bill conveyance direction in each of the functional units at approximately 90 degrees.

In the case where the front unit 60 and the circulation conveyance unit 61 are connected and coupled to each other, the first conveyance surface 89 and the second conveyance surface 90 oppose each other and form the first conveyance path 23. In the case where the rear unit 62 and the circulation conveyance unit 61 are connected and coupled to each other, the third conveyance surface 91 and the fourth conveyance surface 92 oppose each other and form the second conveyance path 24.

The circulation conveyance unit 61 can be rotated about the rotational shaft 81. An upright position 88 of the circulation conveyance unit 61, which is indicated by a broken line, indicates a state where the circulation conveyance unit 61 and the rear unit 62 are connected and coupled to each other. The circulation conveyance unit 61, which is indicated by a solid line, is in a state of being collapsed to the front case 5 side with the rotational shaft 81 being a center, and indicates a state where the rear unit 62 separates from the circulation conveyance unit 61. Since the third conveyance surface 91 separates from the fourth conveyance surface 92 in this state, the bill that is jammed in the second conveyance path 24 can be taken out. Since the second belt 28 separates from the pinch roller, the bill can be taken out easily. In the example, the description has been made on the mechanism that rotates the circulation conveyance unit 61. However, a mechanism that slides the circulation conveyance unit 61 by using a rail may be used.

The front unit 60 can separate from the circulation conveyance unit 61 by moving the front unit 60 along the second rail 77. Since the first conveyance surface 89 separates from the second conveyance surface 90 in this state, the bill that is jammed in the first conveyance path 23 can be taken out. Since the first belt 27 separates from the pinch roller, the bill can be taken out easily.

The bill processor 1 includes the slide mechanism and the rotation mechanism that move the functional units to expose the first conveyance path 23 and the second conveyance path 24. Thus, it is possible to easily perform maintenance work for the bill conveyance paths. Meanwhile, a mechanism that holds and conveys the bill is not arranged to the first curved conveyance path 25 and the second curved conveyance path 26. Thus, the jammed bill can be taken out easily from the first curved conveyance path 25 and the second curved conveyance path 26.

The front unit 60 includes an openable/closable first maintenance door 65, and the rear unit 62 includes an openable/closable second maintenance door 66 and an openable/closable third maintenance door 67. By opening the first maintenance door 65, it is possible to perform the maintenance work for the first storage unit 86 and the reject unit 87 that are arranged in the front unit 60. By opening the second maintenance door 66, it is possible to perform the maintenance work for the second storage unit 82 that is arranged in the rear unit 62. By opening the third maintenance door 67, it is possible to perform the maintenance work for the third storage unit 83 that is arranged in the rear unit 62.

Next, a description will be made on a primary configuration of the bill processor 1 with reference to the drawings. FIG. 1 is a view illustrating an internal configuration of the bill processor. FIG. 1 is a side view of the bill processor 1.

In the bill processor 1, the functional units that perform identification, conveyance, storage, and the like of the bill are covered with the rear case 4 and the front case 5. The first indicator light 7 and the second indicator light 8 are arranged to the front case 5. The first indicator light 7 indicates the presence of the bill in the bill acceptance slot 2, and the second indicator light 8 indicates the presence of the bill in the bill dispensing slot 3. The bill dispensing slot 3 is provided with a shutter 9. When the shutter 9 is open, the bill can be dispensed from the bill dispensing slot 3. When the shutter 9 is closed, the bill cannot be dispensed from the bill dispensing slot 3.

The accepted bill identification unit 84 is a unit that accepts the bills, separates the accepted bills one by one, identifies the currency denomination of each of the bills that have been separated one by one, and conveys the bills to a next process. A longitudinal direction of the bill corresponds to the right-left direction in FIG. 1. The bill is inserted in a depth direction of the accepted bill identification unit 84, that is, the right direction in FIG. 1 from the bill acceptance slot 2 and conveyed.

An opening is provided to the front case 5, and the bill acceptance slot 2, into which the bill is inserted, is arranged to the opening.

A first guide plate 10 is a plate that guides the bill in the depth direction from the bill acceptance slot 2. A second guide plate 11 is arranged to opposite the first guide plate 10. Together with the first guide plate 10, the second guide plate 11 forms a bill path that guides the bill in the depth direction from the bill acceptance slot 2. The bill is conveyed while a front surface or a back surface thereof opposes the first guide plate 10.

A pressing plate 12 is urged in a direction toward the first guide plate 10 by a spring 13, and presses the bill against the first guide plate 10. A first separation roller 14 is partially projected from a surface of the first guide plate 10 through a through-hole provided to the first guide plate 10. The first separation roller 14 is arranged to oppose the pressing plate 12. The first separation roller 14 is driven by a motor, which is not illustrated. The bill that has been inserted from the bill acceptance slot 2 is sandwiched between the pressing plate 12 and the first separation roller 14, and the bill that comes into contact with the first separation roller 14 is conveyed. In the case where the plurality of the bills is inserted, the plurality of the bills is conveyed in the depth direction one by one in an order from the bill on the first guide plate 10 side. An accepted bill sensor 15 is a sensor that detects the presence or the absence of the bill.

A second separation roller 16 is projected from a through-hole that is provided to the first guide plate 10, and comes into contact with a third separation roller 17. The second separation roller 16 is driven by the motor, which is not illustrated. The third separation roller 17 does not rotate in the bill conveyance direction. In the case where the plurality of the stacked bills is inserted, leading ends of the bills are misaligned along a curved surface of the third separation roller 17 and each abut the curved surface. The bill, the leading end of which is closer to the first guide plate 10 among the bills, is located farther in the depth direction of the bill conveyance path.

The only one bill that is closest to the first guide plate 10 is sandwiched between the second separation roller 16 and the third separation roller 17, and only this bill is conveyed. The separation section is a mechanism that is arranged between the bill acceptance slot 2 and a bill acceptance section conveyor belt 19, separates the plurality of the stacked bills one by one, and passes each of the bills to the bill acceptance section conveyor belt 19.

The bill acceptance section conveyor belt 19 is wound around a plurality of bill acceptance section pulleys 18. The bill acceptance section conveyor belt 19 only needs to be wound around at least the bill acceptance section pulleys 18 at both ends. One of the bill acceptance section pulleys 18 at both of the ends is driven by the motor, which is not illustrated, and the bill acceptance section conveyor belt 19 is thereby driven. Bill acceptance section pinch rollers 20 are urged in a direction toward the bill acceptance section conveyor belt 19. Each of the bills that have been separated one by one is sandwiched between each of the bill acceptance section pinch rollers 20 and the bill acceptance section conveyor belt 19, and is conveyed.

An identification sensor 21 is arranged in an area between the bill acceptance section pinch rollers 20 that are arranged at both ends. The identification sensor 21 is a sensor for identifying the currency denomination of the accepted bill. The identification sensor 21 identifies the currency denomination of the bill that is conveyed by the bill acceptance section pinch rollers 20 and the bill acceptance section conveyor belt 19. A section in which this identification sensor 21 is arranged will be referred to as an identification section. The bill is stored or ejected according to the currency denomination that is identified by the identification sensor 21.

A bill acceptance section entry/exit guide 22 is a conveyance path for the bill to enter the first linear conveyance path 23, and is a curved conveyance path. The accepted bill identification unit 84 is connected to the first conveyance path 23 by the bill acceptance section entry/exit guide 22.

Next, a description will be made on the circulation conveyance unit 61 that constitutes a circulation conveyance path for circulating and conveying the bill.

The first conveyance path 23 is a linear conveyance path that conveys the bill. The second conveyance path 24 is a linear conveyance path that conveys the bill. The first conveyance path 23 and the second conveyance path 24 oppose each other. The first curved conveyance path 25 is a conveyance path that connects an upper end of the first conveyance path 23 and an upper end of the second conveyance path 24. The second curved conveyance path 26 is a conveyance path that connects a lower end of the first conveyance path 23 and a lower end of the second conveyance path 24. The circulation conveyance path that circulates the bill is formed by the first conveyance path 23, the second curved conveyance path 26, the second conveyance path 24, and the first curved conveyance path 25.

A drive mechanism, such as a roller, that comes into contact with the bill and moves the bill is not arranged to the first curved conveyance path 25 and the second curved conveyance path 26. Each of the first curved conveyance path 25 and the second curved conveyance path 26 is a path that is located between a guide for supporting the front surface of the bill and a guide for supporting the back surface of the bill. There is no restriction on arrangement or a shape of the drive mechanism in the first curved conveyance path 25 and the second curved conveyance path 26. Each of the first curved conveyance path 25 and the second curved conveyance path 26 only needs to be a path in a shape, through which the bill can pass. Thus, the shape of each of the first curved conveyance path 25 and the second curved conveyance path 26 can be determined freely. For example, when the first curved conveyance path 25 or the second curved conveyance path 26 is formed as a path in a rounded trapezoidal shape, a length in an up-down direction of the circulation conveyance path can be reduced. In this case, there is no need to provide components constituting a conveyance mechanism or a transmission mechanism for transmitting power from the motor in the first curved conveyance path 25 or the second curved conveyance path 26. Thus, it is possible to secure a space for arranging other components and save a space in the bill processor.

In addition to the accepted bill identification unit 84 for the bill, the bill dispensing unit 85, which dispenses the bill, the first storage unit 86, which stores the bill of the first currency denomination, and the reject unit 87, which stores the bill to be collected, are connected to the first conveyance path 23. A first branch plate 37, a second branch plate 38, and a third branch plate 39, each of which can change a moving direction of the bill in the first conveyance path 23, are arranged to any of the accepted bill identification unit 84, the bill dispensing unit 85, the first storage unit 86, and the reject unit 87. Each of the first branch plate 37, the second branch plate 38, and the third branch plate 39 is driven by an actuator, which is not illustrated. The first branch plate 37 moves the bill, which is moved in the first conveyance path 23, linearly or guides the bill to the bill dispensing unit 85. The second branch plate 38 causes the linear movement of the bill, which moves on the first conveyance path 23, or guides the bill to the first storage unit 86. The second branch plate 38 moves the bill, which is moved in the first conveyance path 23, linearly or guides the bill to the first storage unit 86. The second branch plate 38 also guides the bill from the first storage unit 86 to the first conveyance path 23 so as to dispense the bill. The third branch plate 39 moves the bill, which is moved in the first conveyance path 23, linearly or guides the bill to the reject unit 87. Each of the first branch plate 37, the second branch plate 38, and the third branch plate 39 is driven by the actuator, which is not illustrated, and can move the bill in the desired direction.

The second storage unit 82, which stores the bill of the second currency denomination, and the third storage unit 83, which stores the bill of the third currency denomination, are connected to the second conveyance path 24. A fourth branch plate 40 and a fifth branch plate 41, each of which can change the moving direction of the bill in the second conveyance path 24, is arranged to any of the second storage unit 82 and the third storage unit 83. Each of the fourth branch plate 40 and the fifth branch plate 41 is driven by an actuator, which is not illustrated. The fourth branch plate 40 moves the bill, which is moved in the second conveyance path 24, linearly or guides the bill to the second storage unit 82. The fourth branch plate 40 also guides the bill from the second storage unit 82 to the second conveyance path 24 so as to dispense the bill. The fifth branch plate 41 moves the bill, which is moved in the second conveyance path 24, linearly or guides the bill to the third storage unit 83. The fifth branch plate 41 also guides the bill from the third storage unit 83 to the second conveyance path 24 so as to dispense the bill. Each of the fourth branch plate 40 and the fifth branch plate 41 is driven by the actuator, which is not illustrated, and can move the bill in the desired direction.

There are plural locations, from each of which the bill enters the first linear conveyance path 23 or the second linear conveyance path 24. In the case where the bills enter the conveyance path at different angles, conveyance abnormality frequently occurs at a location with an acute entry angle. By setting the constant entry angle for the bills, it is possible to eliminate the location that is prone to the above problem and thus to enable the stable conveyance. There are also plural locations, from each of which the bill exits the first linear conveyance path 23 or the second linear conveyance path 24. In the case where the bills exit the conveyance path at different angles, the conveyance abnormality frequently occurs at a location with an acute exit angle. By setting the constant exit angle for the bills from the conveyance path, it is possible to eliminate the location that is prone to the above problem and thus to enable the stable conveyance.

The first conveyance path 23 includes: the first belt 27 that is wound around a first driven pulley 29 and a first drive pulley 30; and a plurality of conveyance section pinch rollers 35, each of which is urged in a direction toward the first belt 27. The bill is sandwiched between the first belt 27 and each of the conveyance section pinch rollers 35 and conveyed. The first drive pulley 30 is driven by the motor, which is not illustrated, and the first belt 27 is driven by the first drive pulley 30. At positions corresponding to some of the conveyance section pinch rollers 35, support rollers 36 are each arranged to hold the first belt 27 with respective one of the conveyance section pinch rollers 35. This support roller 36 prevents flexure of the first belt 27 that is pressed by respective one of the conveyance section pinch rollers 35. The conveyance section pinch rollers 35 can also be arranged in a manner to correspond to the first driven pulley 29 and the first drive pulley 30. Each of the conveyance section pinch rollers 35 arranged to oppose the first belt 27 is supported in a freely rotatable manner by any of the accepted bill identification unit 84, the bill dispensing unit 85, the first storage unit 86, and the reject unit 87.

The second conveyance path 24 includes: the second belt 28 that is wound around a second driven pulley 31 and a second drive pulley 32; and the plurality of conveyance section pinch rollers 35, each of which is urged in a direction toward the second belt 28. The bill is sandwiched between the second belt 28 and each of the conveyance section pinch rollers 35 and conveyed. The second drive pulley 32 is driven by the motor, which is not illustrated, and the second belt 28 is driven by the second drive pulley 32. At positions corresponding to some of the conveyance section pinch rollers 35, the support rollers 36 are each arranged to hold the second belt 28 with respective one of the conveyance section pinch rollers 35. This support roller 36 prevents flexure of the second belt 28 that is pressed by respective one of the conveyance section pinch rollers 35. The conveyance section pinch rollers 35 can also be arranged in a manner to correspond to the second driven pulley 31 and the second drive pulley 32. Each of the conveyance section pinch rollers 35 arranged to oppose the second belt 28 is supported in the freely rotatable manner by any of the second storage unit 82 and the third storage unit 83.

The first belt 27 and the second belt 28 are operated in the interlocking manner when drive power is transmitted thereto by a transmission belt 34. The transmission belt 34 is wound around: a pulley, which is not illustrated, is fixed to a rotational shaft of the first drive pulley 30, and is arranged in a depth direction of the sheet; and a pulley, which is not illustrated, is fixed to a rotational shaft of the second drive pulley 32, and is arranged in the depth direction of the sheet. A tension roller 33 prevents flexure of the transmission belt 34, and applies an appropriate tensile force to the transmission belt 34.

In order to reduce a length in the depth direction of the bill processor 1, the circulation conveyance path for the bill is formed in a vertically long rounded rectangular shape in the side view of the bill processor 1. In FIG. 1, the right-left direction corresponds to the depth direction of the bill processor 1. In the side view of the bill processor 1, the plural functional units are stacked in the up-down direction in a manner to oppose the first conveyance path 23 of the circulation conveyance path for the bill, and the plural functional units are stacked in the up-down direction in a manner to oppose the second conveyance path 24. Side surfaces of the functional units and side surfaces of the circulation conveyance unit 61 constitute the first conveyance path 23 and the second conveyance path 24. In this way, the circulation conveyance unit 61 is downsized in the depth direction of the bill processor 1.

Next, a description will be made on the bill dispensing unit 85.

A bill dispensing unit tray 44 stores a stack of the bills to be dispensed. The bills that are stacked and stored in the bill dispensing unit tray 44 can be taken out from the bill dispensing slot 3. When the shutter 9 is opened, the bill that is stored in the bill dispensing unit tray 44 can be taken out from the bill dispensing slot 3. When the shutter 9 is closed, the bill cannot be taken out from the bill dispensing slot 3.

The first branch plate 37 is driven to change a direction to guide the bill, and guides the bill in a direction toward the bill dispensing slot 3 from the first conveyance path 23. By driving a bill dispensing unit belt 42 and a bill dispensing unit roller 43, the bill that is guided by the first branch plate 37 is conveyed to the bill dispensing unit tray 44. A pinch roller, which is not illustrated, is arranged to oppose the bill dispensing unit belt 42. This pinch roller is urged in a direction toward the bill dispensing unit belt 42. The bill is sandwiched between the bill dispensing unit belt 42 and the pinch roller, and the bill dispensing unit belt 42 rotates to convey the bill to the bill dispensing unit tray 44. The bill dispensing unit roller 43 includes a plurality of flexible blades. The bills that have been conveyed by the bill dispensing unit belt 42 and the pinch roller are thrown by the blades and stacked on the bill dispensing unit tray 44. When the bills in a specified amount are stored in the bill dispensing unit tray 44, the shutter 9 is opened, and the bills can be taken out from the bill dispensing slot 3.

Next, a description will be made on the first storage unit 86.

The first storage unit 86 can store the stacked bills of the first currency denomination and eject the stored bills one by one.

The second branch plate 38 is driven to any of the following positions: a position to guide the bill from the first conveyance path 23 to the first storage unit 86; a position to convey the bill along the first conveyance path 23; and a position to guide the bill from the first storage unit 86 to the first conveyance path 23, and the bill is conveyed according to the position.

In the case where the bill is stored in the first storage unit 86, the second branch plate 38 is driven to change the direction to guide the bills, and guides the bill in a direction toward a first storage unit tray 47 from the first conveyance path 23. A first storage unit drive roller 45 stores or ejects the bill when being driven by the motor, which is not illustrated, and changing a rotational direction thereof. A first storage unit pinch roller 46 is urged in a direction toward the first storage unit drive roller 45, sandwiches the bill with the first storage unit drive roller 45, and conveys the sandwiched bill. Depending on the rotational direction of the first storage unit drive roller 45, the bill is conveyed to the first storage unit tray 47 or conveyed in a reverse direction. The bills that have been conveyed to the first storage unit tray 47 are stacked and stored on the first storage unit tray 47.

In the case where the bill is sent from the first storage unit 86 to the first conveyance path 23, the second branch plate 38 is driven to change the direction to guide the bill, and then the bill is guided from the first storage unit 86 to the first conveyance path 23. The first storage unit drive roller 45 rotates in a direction to eject the bill, sandwiches the bill with the first storage unit pinch roller 46, and conveys the sandwiched bill to the first conveyance path 23. The bill is sandwiched between the support roller 36 and the conveyance section pinch roller 35 and conveyed in the first conveyance path 23.

A first storage unit lifting/lowering mechanism 48 lifts/lowers the first storage unit tray 47. When the bills are ejected, the first storage unit lifting/lowering mechanism 48 lifts/lowers the first storage unit tray 47 according to operation of a separation mechanism, which is not illustrated, separates the plurality of the stacked bills one by one, and sends each of the bills to a position between the first storage unit drive roller 45 and the first storage unit pinch roller 46.

Next, a description will be made on the reject unit 87.

The reject unit 87 can store the stacked bills of the currency denomination to be collected. For example, the reject unit 87 stores old bills, and bills with low circulation, or the like.

The third branch plate 39 is driven to any of the following positions: a position to guide the bill from the first conveyance path 23 to the reject unit 87; and a position to convey the bill along the first conveyance path 23, and the bill is conveyed according to the position.

In the case where the bill is stored in the reject unit 87, the third branch plate 39 is driven to change the direction to guide the bill, and guides the bill in a direction toward a reject unit tray 51 from the first conveyance path 23. A reject unit drive roller 49 is driven by the motor, which is not illustrated, to store the bill. A reject unit pinch roller 50 is urged in a direction toward the reject unit drive roller 49, sandwiches the bill with the reject unit drive roller 49, and conveys the sandwiched bill to the reject unit tray 51. The conveyed bills are stacked and stored on the reject unit tray 51.

Next, a description will be made on the second storage unit 82.

The second storage unit 82 can store the stacked bills of the second currency denomination and eject the stored bills one by one.

The fourth branch plate 40 is driven to any of the following positions: a position to guide the bill from the second conveyance path 24 to the second storage unit 82; a position to convey the bill along the second conveyance path 24; and a position to guide the bill from the second storage unit 82 to the second conveyance path 24, and the bill is conveyed according to the position.

In the case where the bill is stored in the second storage unit 82, the fourth branch plate 40 is driven to change the direction to guide the bill, and guides the bill in a direction toward a second storage unit tray 54 from the second conveyance path 24. A second storage unit drive roller 52 stores or ejects the bill when being driven by the motor, which is not illustrated, and changing a rotational direction thereof. A second storage unit pinch roller 53 is urged in a direction toward the second storage unit drive roller 52, sandwiches the bill with the second storage unit drive roller 52, and conveys the sandwiched bill to the second storage unit tray 54. The conveyed bills are stacked and stored on the second storage unit tray 54.

In the case where the bill is sent from the second storage unit 82 to the second conveyance path 24, the fourth branch plate 40 is driven to change the direction to guide the bill, and then the bill is guided in the bill conveyance direction of the second conveyance path 24. The second storage unit drive roller 52 rotates in a direction to eject the bill, sandwiches the bill with the second storage unit pinch roller 53, and conveys the sandwiched bill to the second conveyance path 24. The bill is sandwiched between the support roller 36 and the conveyance section pinch roller 35 and conveyed in the second conveyance path 24.

A second storage unit lifting/lowering mechanism 55 lifts/lowers the second storage unit tray 54. When the bills are ejected, the second storage unit lifting/lowering mechanism 55 lifts/lowers the second storage unit tray 54 according to operation of a separation mechanism, which is not illustrated, separates the plurality of the stacked bills one by one, and sends each of the bills to a position between the second storage unit drive roller 52 and the second storage unit pinch roller 53.

Next, a description will be made on the third storage unit 83.

The third storage unit 83 can store the stacked bills of the third currency denomination and eject the stored bills one by one.

The fifth branch plate 41 is driven to any of the following positions: a position to guide the bill from the second conveyance path 24 to the third storage unit 83; a position to convey the bill along the second conveyance path 24; and a position to guide the bill from the third storage unit 83 to the second conveyance path 24, and the bill is conveyed according to the position.

In the case where the bill is stored in the third storage unit 83, the fifth branch plate 41 is driven to change the direction to guide the bill, and guides the bill in a direction toward a third storage unit tray 58 from the second conveyance path 24. A third storage unit drive roller 56 stores or ejects the bill when being driven by the motor, which is not illustrated, and changing a rotational direction thereof. A third storage unit pinch roller 57 is urged in a direction toward the third storage unit drive roller 56, sandwiches the bill with the third storage unit drive roller 56, and conveys the sandwiched bill to the third storage unit tray 58. The conveyed bills are stacked and stored on the third storage unit tray 58.

In the case where the bill is sent from the third storage unit 83 to the second conveyance path 24, the fifth branch plate 41 is driven to change the direction to guide the bill, and then the bill is guided in the bill conveyance direction of the second conveyance path 24. The third storage unit drive roller 56 rotates in a direction to eject the bill, sandwiches the bill with the third storage unit pinch roller 57, and conveys the sandwiched bill to the second conveyance path 24. The bill is sandwiched between the support roller 36 and the conveyance section pinch roller 35 and conveyed in the second conveyance path 24.

A third storage unit lifting/lowering mechanism 59 lifts/lowers the third storage unit tray 58. When the bills are ejected, the third storage unit lifting/lowering mechanism 59 lifts/lowers the third storage unit tray 58 according to operation of a separation mechanism, which is not illustrated, separates the plurality of the stacked bills one by one, and sends each of the bills to a position between the third storage unit drive roller 56 and the third storage unit pinch roller 57.

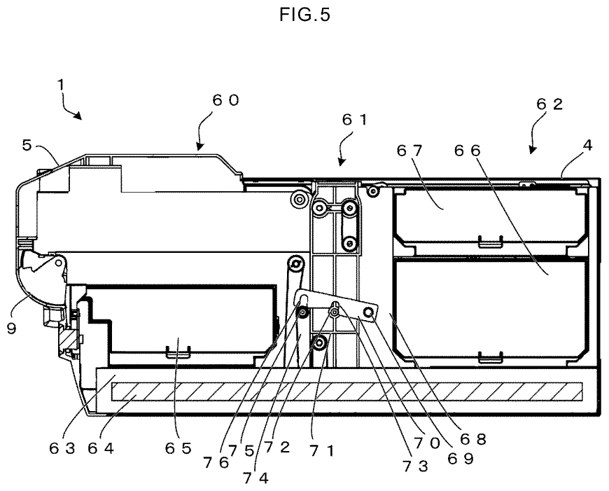

FIG. 5 is a first view illustrating an overview of the functional units of the bill processor. FIG. 5 is a side view of the bill processor 1.

The front unit 60, the circulation conveyance unit 61, and the rear unit 62 can be coupled. The rear unit 62 includes a rear frame 68 that fixes the functional units. The rear frame 68 is provided with a fixed shaft 69 and a fixing lever 70 that is rotatably supported by the shaft 69. The fixing lever 70 includes a first recess 73 and a second recess 76. The circulation conveyance unit 61 includes an intermediate frame 71 that fixes the functional units. The intermediate frame 71 includes an intermediate engagement projection 72 that is engaged with the first recess 73. The front unit 60 includes a front frame 74 that fixes the functional units. The front frame 74 includes an front engagement projection 75 that is engaged with the second recess 76. By coupling the front unit 60, the circulation conveyance unit 61, and the rear unit 62, gears, which are not illustrated, are coupled, can transmit the drive power to each of the units, and can drive the units in the interlocking manner.

In a state where the front unit 60 abuts the circulation conveyance unit 61 and the circulation conveyance unit 61 abuts the rear unit 62, the fixing lever 70 rotates to engage the intermediate engagement projection 72 with the first recess 73 and engage the front engagement projection 75 with the second recess 76. The front unit 60, the circulation conveyance unit 61, and the rear unit 62 are fixed in the coupled state.

In the front unit 60, the front frame 74 includes the openable/closable first maintenance door 65. In the rear unit 62, the rear frame 68 includes the openable/closable second maintenance door 66 and the openable/closable third maintenance door 67. Each of the doors can be opened/closed.

When the door is opened, it is possible to access the respective functional unit stored inside and perform the maintenance work for the bill processor 1.

An engagement section, which is not illustrated, in the base frame 64 is slidably attached to the first rail 63, and the base frame 64 can be moved along the first rail 63. The first rail 63 is a linear rail that is arranged in the depth direction of the bill processor 1. By moving the base frame 64, the front unit 60, the circulation conveyance unit 61, and the rear unit 62 can be taken out of the rear case 4. In this state, the first maintenance door 65, the second maintenance door 66, and the third maintenance door 67 can be opened/closed, and the fixing lever 70 can rotate.

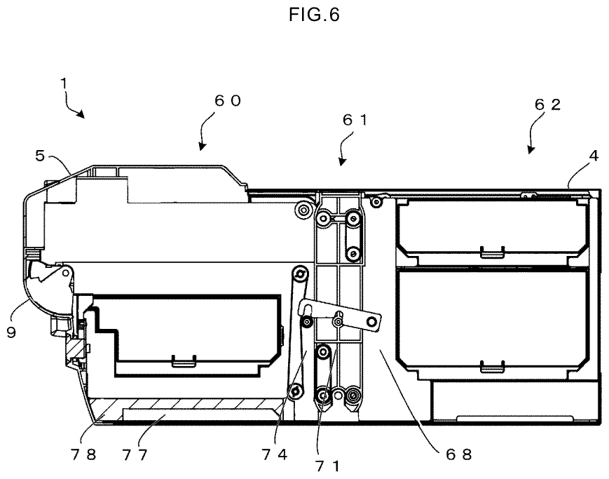

FIG. 6 is a second view illustrating the overview of the functional units of the bill processor. FIG. 6 is a side view of the bill processor 1. The front unit 60 and the front case 5 are fixed to the slide frame 78 that is slidably engaged with the second rail 77. The second rail 77 is arranged in parallel with the first rail 63. By releasing the fixing lever 70, the front unit 60 can be moved to pull away from the circulation conveyance unit 61.

What is claimed is:

1. A bill processor comprising:
an accepted bill identification unit having a bill acceptance slot to accept a bill, a separation section to separate a plurality of the accepted bills one by one, and an identification sensor to identify a currency denomination of each of the bills that have been separated one by one;
a plurality of storage units, each of which stores the bill;
a bill dispensing unit having a bill dispensing slot to dispense the bill to outside; and
a circulation conveyance path that conveys the bill to enable circulation of the bill, wherein
the circulation conveyance path has:
a first linear conveyance path;
a second linear conveyance path that is arranged to oppose the first conveyance path;
a first curved conveyance path that connects one end of the first conveyance path and one end of the second conveyance path and includes a curved section; and
a second curved conveyance path that connects another end of the first conveyance path and another end of the second conveyance path and includes a curved section, and
a conveyance path for the bill in the accepted bill identification unit, a conveyance path for the bill in each of the storage units, and a conveyance path for the bill in the bill dispensing unit are connected to any of the first conveyance path and the second conveyance path, each of which is a linear portion of the circulation conveyance path.

2. The bill processor according to claim 1, wherein
the accepted bill identification unit and the bill dispensing unit are connected to the first conveyance path, and at least one of the storage units is connected to the second conveyance path.

3. The bill processor according to claim 2, wherein
a side surface of each of the accepted bill identification unit, the bill dispensing unit, and the storage units on the circulation conveyance path side constitutes a part of the first conveyance path or the second conveyance path.

4. The bill processor according to claim 3, wherein
the first conveyance path includes: a first belt that comes into contact with one surface of the bill and supports the bill; and a first pinch roller that is urged in a direction toward the first belt, and the bill is sandwiched between the first belt and the first pinch roller and conveyed, and
the second conveyance path includes: a second belt that comes into contact with another surface of the bill and supports the bill; and a second pinch roller that is urged in a direction toward the second belt, and the bill is sandwiched between the second belt and the second pinch roller and conveyed.

5. The bill processor according to claim 4, further comprising:
a base frame in which a front unit, a circulation conveyance unit, and a rear unit are separately arranged in a manner to allow coupling thereof, the front unit including the accepted bill identification unit and the bill dispensing unit, the circulation conveyance unit including the first curved conveyance path, the second curved conveyance path, the first belt for supporting the one surface of the bill, and the second belt for supporting the one surface of the bill, and the rear unit including at least one of the storage units, wherein
the first pinch roller is arranged to the front unit, the first belt is arranged to the circulation conveyance unit, and, when the front unit and the circulation conveyance unit are coupled, the first conveyance path in which the first pinch roller and the first belt contact each other is formed, and
the second pinch roller is arranged to the rear unit, the second belt is arranged to the circulation conveyance unit, and, when the rear unit and the circulation conveyance unit are coupled, the second conveyance path in which the second pinch roller and the second belt contact each other is formed.

6. The bill processor according to claim 5, wherein
the front unit can be moved in a manner to be able to contact/separate from the circulation conveyance unit, and
the circulation conveyance unit can be moved in a manner to be able to contact/separate from the rear unit.

7. The bill processor according to claim 6, wherein
the base frame is arranged with a rotational shaft that supports the circulation conveyance unit in a freely rotatable manner, the circulation conveyance unit is pivotally supported by the rotational shaft, the circulation conveyance unit rotates with an end on the first curved conveyance path side being a free end with respect to the rear unit fixed to the base frame, and the second conveyance path is exposed by the rotation.

8. The bill processor according to claim 7, wherein
the front unit and the base frame are connected by a slide mechanism, and, when the front unit is slid in a direction away from the circulation conveyance unit fixed to the base frame, the first conveyance path is exposed.

9. The bill processor according to claim 6, wherein
the rear unit has a lever that is rotatably and pivotally supported, and, when the lever is engaged with the front unit and the circulation conveyance unit, movement of the front unit and the circulation conveyance unit is restricted.

10. The bill processor according to claim 9, wherein
the lever includes a first recess and a second recess,
the front unit has a front engagement projection that is engaged with the first recess,
the circulation conveyance unit has an intermediate engagement projection that is engaged with the second recess, and
in a state where the front unit is in contact with the circulation conveyance unit and the circulation conveyance unit is in contact with the rear unit, the front engagement projection is engaged with the first recess, the intermediate engagement projection is engaged with the second recess, and the front unit, the circulation conveyance unit, and the rear unit are thereby coupled.

11. The bill processor according to claim 8, wherein
an entry angle at which the bill enters the circulation conveyance path from the accepted bill identification unit is equal to an entry angle at which the bill enters the circulation conveyance path from each of the storage units.

12. The bill processor according to claim 8, wherein
an entry angle at which the bill enters the bill dispensing unit from the circulation conveyance path is equal to an entry angle at which the bill enters each of the storage units from the circulation conveyance path.
